(19) United States
(12) Patent Application Publication
(10) Pub. No.: US 2022/0354121 A1
(43) Pub. Date: Nov. 10, 2022

(54) EXTERNALLY HEATED GEL REPELLENT

(71) Applicant: Lamplight Farms Incorporated, Menomonee Falls, WI (US)

(72) Inventors: KYLE RESSLER, West Bend, WI (US); Lucas Henry Zeitler, Wauwatosa, WI (US)

(21) Appl. No.: 17/739,433

(22) Filed: May 9, 2022

Related U.S. Application Data
(60) Provisional application No. 63/185,820, filed on May 7, 2021.

(51) Int. Cl. A01N 53/00; A01P 17/00; A01N 25/04; A01M 29/12

(52) U.S. Cl. CPC A01N 53/00; A01P 17/00; A01N 25/04; A01M 29/12

(57) ABSTRACT

A composition includes a gel carrier having a gel phase at a first, ambient temperature and a liquid phase at a second, higher temperature, and an insect repellent chemical in the carrier. The repellent chemical has substantially no volatilization from the gel carrier when the gel carrier is in the gel phase, but volatilizes from the gel carrier when the gel carrier is in the liquid phase.

### CROSS-REFERENCE TO RELATED CASES

This application claims the benefit of U.S. provisional patent application Ser. No. 63/185,820, filed on May 7, 2021, and incorporates such provisional application by reference into this disclosure as if fully set out at this point.

### FIELD OF THE INVENTION

This disclosure relates to insect repellent systems in general and, more particularly, to an insect repellent gel and a systems and methods utilizing the same.

### BACKGROUND OF THE INVENTION

Insect repellents may be worn on the skin for repelling insects from an individual, or may be dispersed into the local atmosphere and work to repel insects from a localized area.

Repellents that are dispersed into the local atmosphere must have sufficient volatility when deployed to disperse into the atmosphere at levels at which they remain effective, but must not be so volatile as to rapidly exhaust themselves such that constant replenishment or an unworkable amount of product is needed.

What is needed is a composition, system, and/or method for addressing the above and related issues.

### SUMMARY OF THE INVENTION

The invention of the present disclosure, in one aspect thereof, comprises a composition including a gel carrier having a gel phase at a first, ambient temperature and a liquid phase at a second, higher temperature, and an insect repellent chemical in the carrier. The repellent chemical has substantially no volatilization from the gel carrier when the gel carrier is in the gel phase, but volatilizes from the gel carrier when the gel carrier is in the liquid phase.

In some embodiments, the repellent comprises metofluthrin. The metofluthrin may comprises about 4% weight/weight of the composition, or about 8% weight/weight of the composition.

The gel carrier may comprise isopropyl myristate. The isopropyl myristate may comprise about 84% weight/weight of the composition.

Some embodiments contain Rheostrux™ 200 at about 8% weight/weight of the composition.

The invention of the present disclosure, in another aspect thereof, comprises an insect repellent device having a container, and a gel carrier in the container that has a gel phase at a first, ambient temperature and a liquid phase at a second, higher temperature. The gel carrier contains an insect repellent that is volatilized from the gel carrier in the liquid phase.

Some embodiments include a volatilized insect repellent permeable membrane covering the container.

The insect repellent device may further comprise a heat source that applies heat to the gel carrier to change the gel carrier from the gel phase to the liquid phase. A foil may interpose the heat source and the container.

In some embodiments, the insect repellent comprises at least 4% weight/weight of the gel carrier. The insect repellent may comprise metofluthrin.

In some embodiments, the gel carrier comprises at least 84% weight/weight isopropyl myristate. The gel carrier may also comprise a rheology modifier.

The invention of the present disclosure, in another aspect thereof, comprises a method including combining a first quantity of Rheostrux™ with a second quantity of isopropyl myristate in a vessel, heating and stirring the first and second quantities until a dissolved and homogenous liquid has formed, allowing the first and second quantities to begin to cool and adding third quantity of metofluthrin to the first and second quantities to produce an insect repellent gel carrier composition in a liquid phase, and cooling the insect repellent gel carrier composition from the liquid phase to a solid gel phase. The first quantity is about 8% weight by weight, the second quantity is about 88% weight by weight, and the third quantity is about 4% weight by weight of insect repellent gel carrier composition.

The method may also include packing the insect repellent gel carrier composition in a receptable. The receptable may be placed into a portable device having an internal resistive heating element. The method may include heating the insect repellent gel carrier composition using the internal resistive heating element back to the liquid phase thereby volatilizing the metofluthrin. In some embodiments, the method includes allowing the insect repellent gel carrier composition to cool to the solid gel phase thereby stopping the volatilization of the metofluthrin.

### BRIEF DESCRIPTION OF THE DRAWINGS

FIG. 1 is a perspective view of one embodiment of a gel repellent container according to aspects of the present disclosure.

FIG. 2 is a perspective view of another embodiment of a gel repellent container according to aspects of the present disclosure on a foil disk.

FIG. 3 is an elevation view of the gel repellent container of FIG. 2 received within a hanging heater apparatus.

FIG. 4 is a schematic diagram of one embodiment of a portable repellent device according to aspects of the present disclosure.

FIG. 5 is a scatter plot of repellent volatilization rate versus temperature for some repellent gels of the present disclosure.

FIG. 6 is a scatter plot of repellent volatilization rate versus change in weight of some repellent gels of the present disclosure.

### DETAILED DESCRIPTION OF THE PREFERRED EMBODIMENTS

In various embodiments, the present disclosure provides for an insect repellent composition and system for outdoor recreational use. An insect repellent composition according to the present disclosure may comprise a repellent chemical such as pyrethrin, pyrethroids, metofluthrin, and/or another suitable repellent.

The repellent chemical may be infused into a gel carrier. By application of heat, the gel may release the repellent chemical. Stated another way, application of heat may allow the repellent chemical to diffuse or volatilize out of the gel and into the local atmosphere. The composition of the gel carrier, and the heat applied, may control the rate at which the repellent is volatilized and, in turn, the physical area and length of time over which the repellent chemical is active.

As explained further below, in some embodiments, compositions of the present disclosure remain in solid or gel form until heated, to induce a phase change. The composition may be a gel at room or ambient temperature and become a liquid when heat is applied. For purposes of the present disclosure, ambient temperature may be any temperature resulting from exposure to an indoor or natural environment, but without addition of heat or flame to the gel itself. For example, for purposes of the present disclosure, ambient temperature may range from below 0° C. to 45° C.

In the liquid form, compositions of the present disclosure may allow the repellent to disperse or volatilize into the atmosphere. Removal of heat can allow the liquid to return to solid or gel form, which stops or substantially minimizes volatilization of the chemical repellent remaining in the composition. Thus, unlike some other known compositions, compositions of the present disclosure can be partially used and then saved for further future use.

According to some embodiments, the gel carrier comprises a carrageenan or carrageenin. These substances are a family of natural linear sulfated polysaccharides that are extracted from red edible seaweeds. Carrageenans are widely used in the food industry, for their gelling, thickening, and stabilizing properties. Carrageenans are large, highly flexible molecules that form curling helical structures. This gives them the ability to form a variety of different gels at room temperature. All carrageenans are high-molecular-weight polysaccharides and mainly made up of alternating 3-linked b-D-galac-topyranose (G-units) and 4-linked a-D-galactopyranose (D-units) or 4-linked 3,6-anhydro-a-D-galactopyranose (DA-units), forming the disaccharide repeating unit of carrageenans.

In another embodiment, the gel carrier is high-purity synthetic isoparaffin solvent such as Isopar® available from ExxonMobile. An example composition based on Isopar® includes Isopar® M at 88% w/w, 8% w/w Rheostrux™ 100 (a rheology modifier available from Croda International), and 4% w/w metofluthrin (“w/w” being shorthand for “weight/weight”).

In another embodiment, the composition includes 88% w/w isopropyl myristate (IPM), 8% w/w Rheostrux™ 200, and 4% w/w metofluthrin. In another IPM based formulation, the composition includes 84% w/w IPM, 8% w/w Rheostrux™ 200, and 8% w/w metofluthrin.

In some embodiments, the composition consists only of those ingredients listed in specific examples. In other embodiments, other ingredients maybe present. Other ingredients may include, without limitation, dyes, scents, and other admixtures.

Various methods may be utilized to produce the compositions detailed above. In one embodiment, IPM based compositions of the present disclosure may be produced as follows: 1) weigh Rheostrux™ 200 into a container; 2) add IPM to the container; 3) stir the resultant mixture under an applied heat of 150° C.; 4) at around 75° C. the composition becomes clear and colorless but additional stirring (e.g., 5 minutes or more) may increase/ensure homogeneity; 5) continue stirring, and allow the gel composition to cool to approximately 60° C. whereupon metofluthrin may be added. At about 50° C. (or higher) the composition can be poured into vessels or containers, where it will gel as it cools to ambient temperature. As is known on the art, colorants, dyes, scents or other admixtures can also be added.

Although the foregoing IPM based compositions are known to applicant to produce satisfactory results at 4% w/w metofluthrin and 8% w/w metofluthrin, other embodiments may comprise more or less metofluthrin, offset by correspondingly more or less IPM. In various embodiments, the metofluthrin ranges from about 4% w/w to about 16% w/w.

Application of heat to the formulated gel repellent compositions result in volatilization of the repellent and/or a phase change of the gel carrier (e.g., from solid or solid to liquid). With the gel carrier altered to a liquid form, volatilization of the repellent is readily achieved, while in gel form, little to no repellent is dispersed from the composition.

Various experiments were conducted utilizing the 4% w/w metofluthrin and the 8% w/w metofluthrin compositions discussed above. Various amounts of these compositions (weighing from about 1.5 grams to about 5 grams) were placed into shallow aluminum containers having a diameter of 4.5 cm. These were placed on hot plates of varying temperatures and the volatilization rate of the metofluthrin repellent in mg/hour was observed.

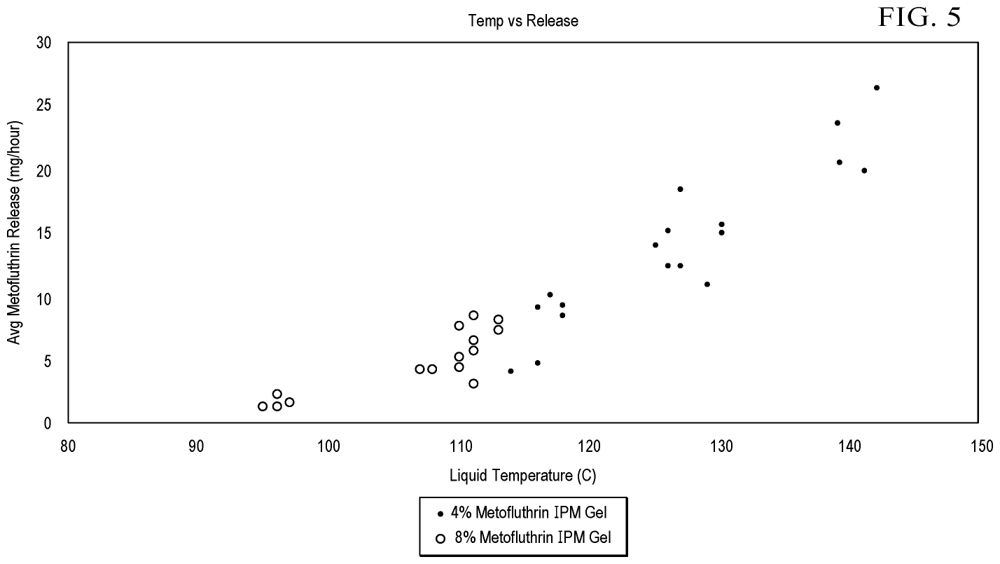

FIG. 5 summarizes the results of these experiments. It can be seen that the rate of volatilization or release of metofluthrin varies with temperature of the gel and with initial concentration of the repellent. 7-12 mg/hour of metofluthrin release is known to be sufficient for local repellency purposes. As can be seen, this is achievable with either the 4% w/w or the 8% w/w metofluthrin compositions. While effective repellence is achievable with 4%, 8% or other amounts of metofluthrin, the total amount of repellent is higher per volume or per unit weight in the higher concentration compositions. Thus increasing the concentration of metofluthrin (within limits that allows the gel carrier to operate satisfactorily) may prolong the usefulness of the composition at a given temperature.

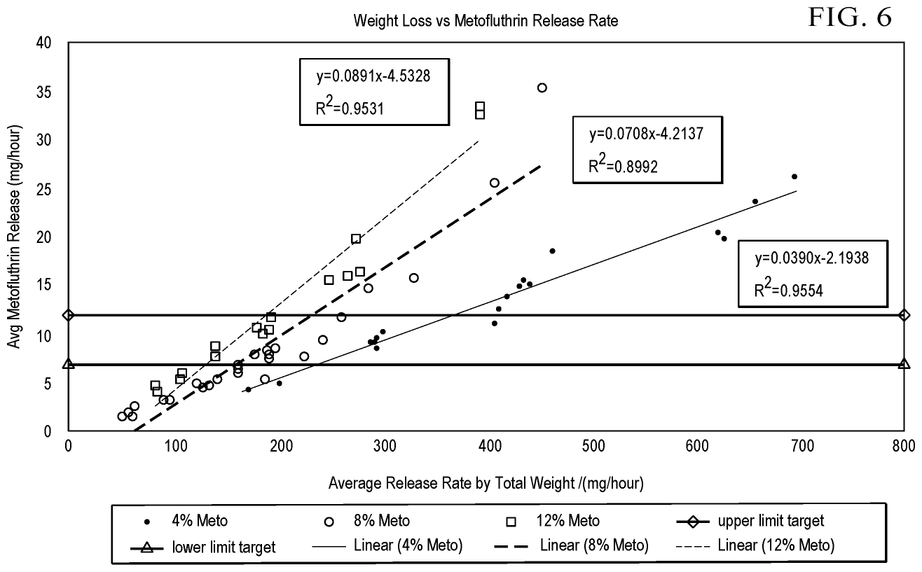

Referring now to FIG. 6, a scatter plot of repellent volatilization rate versus change in weight of some repellent gels of the present disclosure is shown. The data of FIG. 6 was based upon experimental determination of the release rate of metofluthrin versus the total weight lost from the gel carrier over the same time frame. As can be seen, the release rate of metofluthrin in mg/hour can be reliably correlated to the total loss of weight of the carrier gel in mg/hour. Thus, metofluthrin release rates can be assessed utilizing the loss in weight of the associated gel without the time and expense associated with complex equipment needed to analysis and quantify gases. This allows embodiments of the present disclosure to be easily tailored to a specific release rate of a repellent, particularly metofluthrin, in a straightforward fashion.

The repellent compositions of the present disclosure may be deployed in a wide variety of physical forms and with a wide variety of satisfactory heat sources. Potential heat sources include torches, fire pits, pellet heaters, propane pits, string lights, and electric heaters (operating from line voltage, battery, solar, etc.). Where the application includes potential exposure to open flame, the composition may be infused with flame retardants to resist or delay combustion.

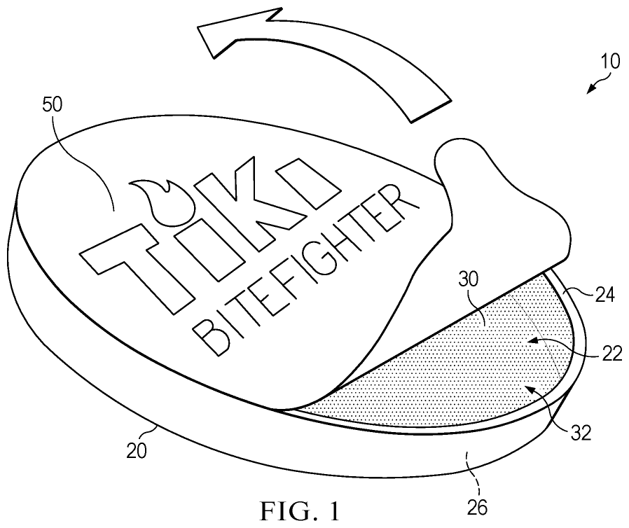

Referring now to FIG. 1 a perspective view of a repellent gel composition of the present disclosure deployed in a sealable container is shown. A packaged gel assembly 10 may include a container 20 defining an opening, cavity, or receptacle 22. The container 20 may have an open top 24 and a closed bottom 26. Gel 30 (representing a repellent gel composition according to the present disclosure) is received within receptacle 22 of container 20. The gel 30 may define an upper surface 32. The gel assembly 10 may also comprise a seal or sealing layer 50. The sealing layer 50 may comprise foil, polymer, a molded cap, or other implement. As discussed above, the gel 30 is composed such that when gel 30 is heated, gel 30 changes phase from a solid or gel phase to a liquid phase and volatilization of the repellent contained therein occurs. When gel 30 is allowed to cool, it changes phase again from a liquid phase to a gel phase. In the solid or gel phase, the gel 30 is stable, and little or no repellent is diffused therefrom.

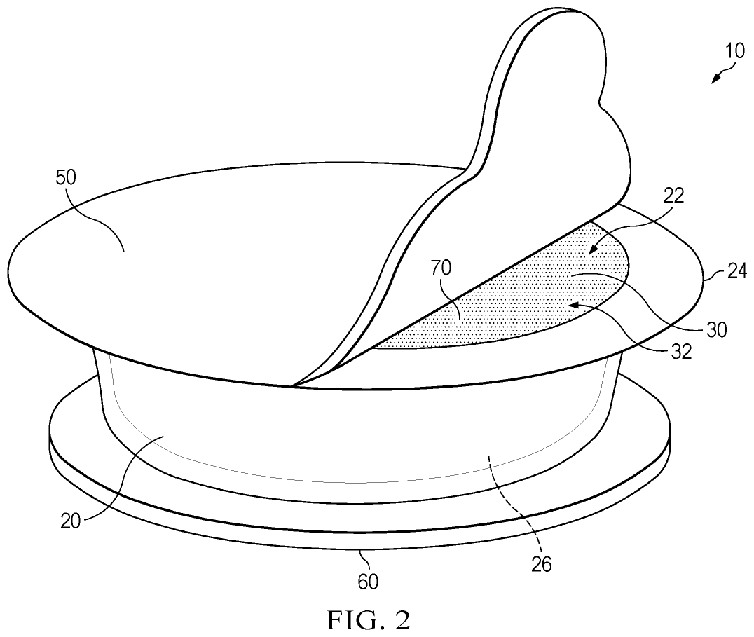

Referring now to FIG. 2 another perspective view the gel repellent container 10 according to aspects of the present disclosure is shown on a foil disk or plate 60. In one embodiment, plate 60 is affixed to closed bottom 26 of container 20 for evenly conducting heat from a heat source. In one embodiment, plate 60 is comprised of foil. A polymer film 70 may be located adjacent to upper surface 32 of gel 30. The polymer film 70 may be permeable by the volatilized repellent and allow diffusion of the same while preventing spillage or inadvertent contact with the gel 30, especially when the gel 30 has changed phase to liquid.

In one embodiment, polymer film 70 has a thickness of approximately 2 mil to 0.24 mil. For example, polymer film 70 may have a thickness of 2 mil, may have a thickness of 0.5 mil or may have a thickness of 0.24 mil. In one embodiment, polymer film 70 is a polypropylene film. The gel 30, with or without the polymer layer 70, can deliver a consistent release rate of repellent across a wide range of temperatures, e.g., from 75° C.-150° C.

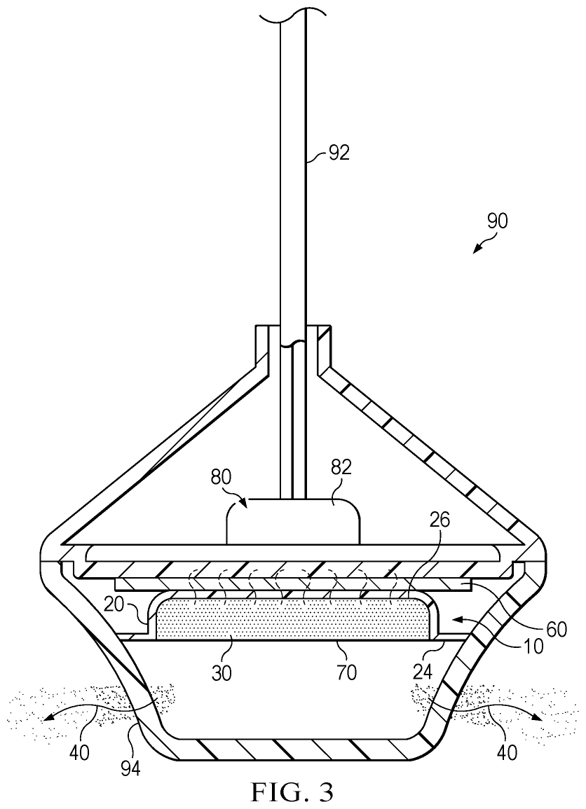

Referring now to FIG. 3 is an elevation view of the gel repellent container 10 of FIG. 2 received within a hanging repellent delivery device 90 is shown. A heater 80 is provided for heating gel 30 for diffusing repellant 40. The heater 80 may comprise an electrically powered resistive heating element 82. In other apparatus, the heat source 80 may be replaced with an open flame or other heat source. The electrically heated heating element 82 may be incorporated within a repellent delivery device 90 suspended from an electric cord 92. Here, the repellent is diffused out the lower end of the delivery device 90 as shown by exemplary vapor path 40.

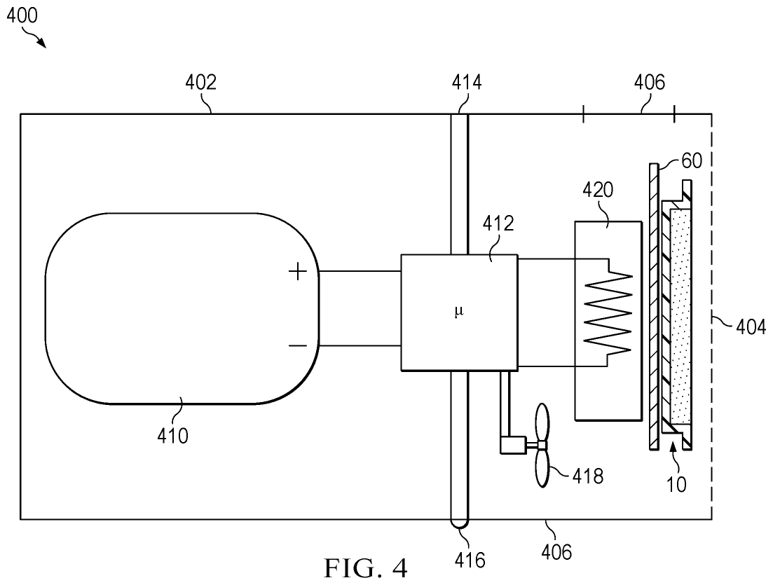

Referring now to FIG. 4, a schematic diagram of one embodiment of a portable repellent device 400 according to aspects of the present disclosure is shown. The device 400 may comprise a case 402, shown only in outline. The case 402 may take different shapes depending upon how it is to be carried or used. The case 402 may comprise a rugged polymer or another suitable material. The case 402 may comprise a screen or perforated diffusion panel 404, as well as an air intake 406 in some embodiments. A door 414 may be provided for accessing or replacing a repellent gel. The repellent gel may be of one of the kinds described herein. In some embodiments, the repellent gel is provided in repellent gel container 10 as described above.

The repellent gel container 10 may be heated by resistive heating element 420. The plate 60 may or may not be present depending upon the construction of the heating element 420. The heating element 420 may be powered by a power cell 410, which may comprise a chemical battery. The power cell 410 may be rechargeable and based on lithium ion technology or other portable and rechargeable battery technology. The power output of the heating element 420 may be from 5-7 Watts with the power cell 410 having an appropriate capacity for powering the device 400 for about 4 hours or more.

The repellent device 400 may be controlled by a microcontroller or controller 412 that controls activation and deactivation of the heating element 420. A thermostat (not shown) may also provide feedback to the controller 402 to keep the heating element 420 at an appropriate temperature. In some cases, the controller 412 continuously or intermittently operates an electric fan 406 moving air in an around the diffuser panel 404. In some embodiments, a separate air intake 406 is provided and air is blown out through the diffuser panel 404 to increase dispersal of volatilized repellent.

The controller 412 may provide one more user controls 416, which may comprise buttons, switches, or other known controls, for turning the device on/off etc. Indicator lights or LEDs (not shown) can also provide feedback from the controller 412 to the user (e.g., battery status, etc.). A charging port 414, such as a micro USB port, may be provided for recharging the power cell 410.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A composition comprising:
a gel carrier having a gel phase at a first, ambient temperature and a liquid phase at a second, higher temperature; and
an insect repellent chemical in the carrier;
wherein the repellent chemical has substantially no volatilization from the gel carrier when the gel carrier is in the gel phase; and
wherein the repellent chemical volatilizes from the gel carrier when the gel carrier is in the liquid phase.

2. The composition of claim 1, wherein the repellent comprises metofluthrin.

3. The composition of claim 2, wherein the gel carrier comprises isopropyl myristate.

4. The composition of claim 3, wherein the metofluthrin comprises about 4% weight/weight of the composition.

5. The composition of claim 3, wherein the metofluthrin comprises about 8% weight/weight of the composition.

6. The composition of claim 3, wherein the isopropyl myristate comprises about isopropyl myristate comprises about 84% weight/weight of the composition.

7. The composition of claim 6, further comprising a Rheostrux™ 200 at about 8% weight/weight of the composition.

8. An insect repellent device comprising:
a container;
a gel carrier in the container that has a gel phase at a first, ambient temperature and a liquid phase at a second, higher temperature;
wherein the gel carrier contains an insect repellent that is volatilized from the gel carrier in the liquid phase.

9. The insect repellent device of claim 8, further comprising a volatilized insect repellent permeable membrane covering the container.

10. The insect repellent device of claim 9, further comprising a heat source that applies heat to the gel carrier to change the gel carrier from the gel phase to the liquid phase.

11. The insect repellent device of claim 10, further comprising a foil interposing the heat source and the container.

12. The insect repellent device of claim 11, wherein the insect repellent comprises at least 4% weight/weight of the gel carrier.

13. The insect repellent device of claim 12, wherein the insect repellent is metofluthrin.

14. The insect repellent device of claim 13, wherein the gel carrier comprises at least 84% weight/weight isopropyl myristate.

15. The insect repellent device of claim 14, wherein the gel carrier comprises a rheology modifier.

16. A method comprising:
combining a first quantity of Rheostrux™ with a second quantity of isopropyl myristate in a vessel;
heating and stirring the first and second quantities until a dissolved and homogenous liquid has formed;
allowing the first and second quantities to begin to cool and adding third quantity of metofluthrin to the first and second quantities to produce an insect repellent gel carrier composition in a liquid phase; and
cooling the insect repellent gel carrier composition from the liquid phase to a solid gel phase;
wherein the first quantity is about 8% weight by weight, the second quantity is about 88% weight by weight, and the third quantity is about 4% weight by weight of insect repellent gel carrier composition.

17. The method of claim 16, further comprising packing the insect repellent gel carrier composition in a receptable.

18. The method of claim 17, further comprising placing the receptable into a portable device having an internal resistive heating element.

19. The method of claim 17, further comprising heating the insect repellent gel carrier composition using the internal resistive heating element back to the liquid phase thereby volatilizing the metofluthrin.

20. The method of claim 19, further comprising allowing the insect repellent gel carrier composition to cool to the solid gel phase thereby stopping the volatilization of the metofluthrin.
